(19) United States
(12) Patent Application Publication
(10) Pub. No.: US 2019/0338402 A1
(43) Pub. Date: Nov. 7, 2019

(54) METHOD FOR MANUFACTURING RAILWAY VEHICLE WHEEL

(71) Applicant: JFE STEEL CORPORATION, Tokyo (JP)

(72) Inventors: Tatsumi KIMURA, Tokyo (JP); Takashi IWAMOTO, Tokyo (JP); Shigeru ENDO, Tokyo (JP); Minoru HONJO, Tokyo (JP); Katsuyuki ICHIMIYA, Tokyo (JP); Kazukuni HASE, Tokyo (JP); Kazuya TOKUNAGA, Tokyo (JP)

(73) Assignee: JFE STEEL CORPORATION, Tokyo (JP)

(21) Appl. No.: 16/517,684

(22) Filed: Jul. 22, 2019

Related U.S. Application Data
(62) Division of application No. 15/313,186, filed on Nov. 22, 2016.

(30) Foreign Application Priority Data
Jun. 11, 2014 (JP) 2014-120542

(51) Int. Cl. C22C 38/02; C22C 38/24; C21D 1/19; C21D 9/34; C22C 38/42; C22C 38/28; C22C 38/26; B60B 17/00; C22C 38/22; C22C 38/06; C22C 38/04; C22C 38/18; C22C 38/00

(52) U.S. Cl. CPC C22C 38/02; C22C 38/24; C21D 1/19; C21D 9/34; C22C 38/42; C22C 38/28; C21D 2211/009; B60B 17/00; C22C 38/22; C22C 38/06; C22C 38/04; C22C 38/18; C22C 38/00; C22C 38/26

(57) ABSTRACT

A method for manufacturing a railway vehicle wheel is provided. The method comprises: in an electric heating furnace or converter, preparing steel containing, in mass %. 0.65% to 0.84% of C, 0.1% to 1.5% of Si, 0.05% to 1.5% of Mn, 0.025% or less of P, 0.015% or less of S, 0.001% to 0.08% of Al, and 0.05% to 1.5% of Cr, the balance being Fe and incidental impurities; casting the steel to obtain a material; hot rolling and/or hot forging the material to form a wheel; heating the wheel to Ac₃ point +50° C. or higher; cooling the wheel from a start temperature of 700° C. or higher to a stop temperature of 500° C. to 650° C. at a rate of 1° C./s to 10° C./s; and then air cooling the wheel.

### CROSS-REFERENCE TO RELATED APPLICATION

This application is a divisional application of U.S. application Ser. No. 15/313,186 filed Nov. 22, 2106, which is a National Stage Application of PCT/JP2015/002886 filed Jun. 9, 2015, which claims priority based on Japanese Patent Application No. 2014-120542 filed Jun. 11, 2014. The disclosures of the prior applications are hereby incorporated by reference herein in their entirety.

### TECHNICAL FIELD

The disclosure relates to a railway vehicle wheel, in particular, to a wheel with excellent wear resistance used in high axle load environments such as heavy haul railways, mining railways and the like. A high axle load environment refers to a situation in which the axle load of the freight is roughly 25 tons or more (a passenger railway is roughly 15 tons or less). For rails used in such railways, rails having high hardness exceeding Brinell hardness of 370 are often used for the purpose of improving durability. The disclosure is related particularly to a wheel that not only has good wear resistance and damage resistance as a wheel but also enables reducing wear and damage of the rail surface when used in combination with such high hardness rails.

### BACKGROUND

In recent years, due to the global economic development in Asia, Africa and the like, railway transportation such as freight railways, mining railways or the like are dramatically increasing. As a result, traveling distances and loaded freight weights have increased to accelerate wear and rolling contact fatigue damage of wheels. Therefore, there is an increasing demand for a wheel for a railway with better durability than before.

Various techniques have been proposed as techniques for improving wear resistance and damage resistance of the wheel. For example, JP2005350769A (PTL 1) describes improving shelling resistance or flat peeling resistance of the wheel by forming the wheel tread using bainite or tempered martensite structure having Vickers hardness of 360 or higher or a mixed structure thereof.

JP2004315928A (PTL 2) and JPH09202937A (PTL 3) describe optimizing the chemical composition of the wheel and adopting pearlite as the microstructure of the tread to improve wear resistance and thermal crack resistance. In particular, PTL2 discloses adopting high carbon pearlite steel to increase the volume ratio of the cementite phase in pearlite to achieve Brinell hardness of 300 or more to improve the thermal crack resistance of the wheel.

JP2012107295A (PTL 4) also describes an invention of optimizing the chemical composition of the wheel to improve the balance in wear resistance, rolling contact fatigue resistance and spalling resistance. This invention was developed by focusing on the hardness and structure of the rim and boss of the wheel, and is based on an approach that using steel with high hardness and low quench hardenability as the wheel material improves characteristics of the wheel.

### CITATION LIST

### Patent Literature

PTL 1: JP2005350769A

PTL 2: JP2004315928A

PTL 3: JPH09202937A

PTL 4: JP2012107295A

### SUMMARY

### Technical Problem

However, the techniques described in PTLs 1 to 4 are techniques that focus on the wear and damage of wheels for the purpose of improving the durability of the wheel itself, and insufficient attention was directed toward wear and damage that occur on the rail when using the wheel. Therefore, in use environments of heavy haul railways which are becoming more and more severe in recent years, wear and damage of wheels and rails in total could not be sufficiently suppressed.

There are very few cases in which the wear resistance and damage resistance of the rail have been considered from the viewpoints of the microstructure and material of the wheel. Some of the only few findings that have been described in the past are the effectiveness of increasing the carbon content of both the rail material and wheel material, and the fact that as the ratio of hardness between the rail and wheel increases, the total wear of the rail and wheel decreases, and reaches a plateau when the ratio exceeds 1.

It could thus be helpful to provide a railway vehicle wheel that can suppress wear and damage of wheels and rails in total.

### Solution to Problem

As a result of intensive studies made to achieve the above object, we discovered the following (1) to (4).
(1) When a pearlitic rail which has been applied in high axle load applications in recent years is used as the counterpart material, the wear and fatigue damage of the wheel and rail in total can be suppressed more when the microstructure of the wheel tread is pearlite than when said microstructure is bainite or tempered martensite which are adopted in PTL 1 or the like.
(2) Of all wheels in which the microstructure of the tread is pearlite, by using wheels in which the pearlite lamellar spacing at least in a region extending from the tread to a depth of 15 mm is 150 nm or less, it is possible to further suppress the wear and fatigue damage of the wheel and rail.
(3) With the wheel referred to in the above (2) where the pearlite lamellar spacing is 150 nm or less, wear resistance, ductility and toughness can all be achieved by optimizing the chemical composition of the wheel material, particularly by containing C in the amount of 0.65 mass % to 0.84 mass %.
(4) Further, in order to ensure ductility and toughness, it is effective to control the block size of the pearlite structure to be 30 pm or less as necessary.

Based on the above discoveries, the most optimum chemical composition and microstructure of the wheel material was found from the viewpoint of reducing the wear and fatigue damage of the wheel and rail in total to complete the disclosure.

Specifically, the primary features of the disclosure are as follows. A railway vehicle wheel containing (consisting of), in mass %: 0.65% to 0.84% of C; 0.1% to 1.5% of Si; 0.05% to 1.5% of Mn; 0.025% or less of P; 0.015% or less of S; 0.001% to 0.08% of Al; and 0.05% to 1.5% of Cr, the balance being Fe and incidental impurities, wherein a microstructure at least in a region extending from a tread to a depth of 15 mm is a pearlite structure, and a pearlite lamellar spacing at least in the region is 150 nm or less.

By adopting the above structure, the wear resistance and surface damage resistance of the wheel and rail in total can be improved.

Further, the railway vehicle wheel contains, in mass %, one or more of: 0.03% to 0.5% of Cu; 0.03% to 0.5% of Ni; 0.02% to 0.2% of Mo; 0.003% to 0.3% of V; 0.003% to 0.1% of Nb; and 0.002% to 0.02% of Ti. This way, strength, ductility, and toughness of the wheel material can be further improved.

Further, the region preferably has a pearlite block size of 30 μm or less. This way, ductility and toughness can be ensured, brittle fracture other than fatigue damage is suppressed, and damage resistance is further improved.

Preferably, the railway vehicle wheel has a 0.2% yield strength (YS) of 700 MPa or more and a yield ratio of 60% or more, when measured at 15 mm inside the tread of the railway vehicle wheel. This way, damage of to the rail, which is used as the counterpart material, can be further reduced.

Preferably, the railway vehicle wheel has an elongation in a tensile test of 12% or more and a Charpy impact value at 20° C. of 15 J or more, when measured at 15 mm inside the tread. This way, brittle fracture other than fatigue damage is suppressed, and damage resistance is further improved. Unless otherwise specified, the 0.2% yield strength, yield ratio, elongation, and Charpy impact value described herein shall stand for the measurements at a position 15 mm inside the tread of the railway vehicle wheel.

Further, a method for manufacturing the railway vehicle wheel described herein, comprises:

preparing steel by steelmaking in an electric heating furnace or converter, the steel containing (consisting of), in mass %, 0.65% to 0.84% of C, 0.1% to 1.5% of Si, 0.05% to 1.5% of Mn, 0.025% or less of P, 0.015% or less of S, 0.001% to 0.08% of Al, and 0.05% to 1.5% of Cr, the balance being Fe and incidental impurities;

casting the steel to obtain a material;

subjecting the material to hot rolling and/or hot forging to form a wheel;

heating the formed wheel to a heating temperature of Ac₃ point+50° C. or higher;

subjecting the wheel to accelerated cooling at a cooling start temperature of 700° C. or higher, a cooling rate of 1° C./s to 10° C./s, a cooling stop temperature of 500° C. to 650° C.; and

then subjecting the wheel to air cooling.

In the method for manufacturing the railway vehicle wheel of the disclosure, the steel further contains, in mass %, one or more of: 0.03% to 0.5% of Cu; 0.03% to 0.5% of Ni; 0.02% to 0.2% of Mo; 0.003% to 0.3% of V; 0.003% to 0.1% of Nb; and 0.002% to 0.02% of Ti.

Further, in the method for manufacturing the railway vehicle wheel described herein, the heating temperature is preferably Ac₃ point+150° C. or lower.

### Advantageous Effect

The disclosure enables suppressing comprehensive wear and damage of not only the wheel but also the rail by appropriately controlling the chemical composition and microstructure of the wheel material. This way, life of the wheel and rail can be improved.

### BRIEF DESCRIPTION OF THE DRAWINGS

In the accompanying drawings:

FIG. 1 is a schematic diagram of a wear test apparatus and test conditions;

FIG. 2 shows the state of the cross section after performing a wear test when the microstructure of the wheel material is varied;

FIG. 3 shows the influence of pearlite lamellar spacing of the wheel material on wear amount of wheel material and rail material;

FIG. 4 shows the state of the cross section after performing a wear test when the pearlite lamellar spacing of wheel material is varied; and

FIG. 5 shows the influence of pearlite block size on Charpy absorption energy (toughness) of the wheel material at 20° C.

### DETAILED DESCRIPTION

Influence of Type of Microstructure

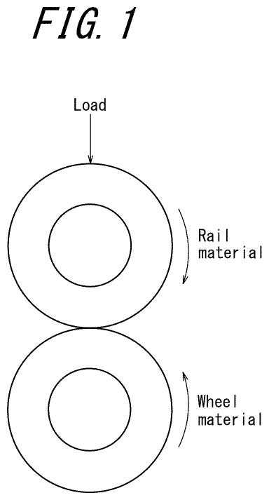

Our products and methods will be described in detail below. First, in order to clarify the influence of the type of microstructure of the wheel tread on the wear and surface damage of the wheel and rail, we prepared wheel materials comprising 3 types of microstructures, namely, pearlite, bainite and tempered martensite, and wear tests were performed for each wheel material in combination with a fixed rail material. For the wear test, we used the two-cylinder wear test apparatus shown in FIG. 1. A wheel material test piece simulating the wheel tread was used as one test piece, and a rail material test piece simulating the rail was used as the other test piece.

The chemical compositions of wheel materials and a rail material used in the test are shown in Table 1. Eutectoid steel was used as the pearlite wheel material and tempered martensite wheel material, and low carbon alloy steel was used as the bainite wheel material. In order to eliminate the influence of factors other than the microstructure, materials having the closest hardness possible (Brinell hardness of approximately 250), were used as the 3 types of wheel materials. As the rail material, a pearlitic rail material (Brinell hardness of 400) used in heavy haul railway applications was used.

The wear test was performed under a Hertzian contact stress of 680 MPa, slip rate of -10% (i.e. the rotation speed of rail material is 10% smaller than the rotation speed of wheel material), and non-lubricating condition. During the wear test, air was blown on the surface where the rail material and the wheel material come into contact. After 2 hours of test time, or 82,000 cycles in terms of the number of rotation on the rail material side, the wear and surface damage of both the wheel material and the rail material were examined. The wear was determined from the difference in weight of the test piece before and after the test. The test was performed twice for each of wheel materials A to C comprising a pearlite structure, bainite structure, and tempered martensite structure.

The results of the wear test are shown in Table 2. Having examined the wear of each of the wheel material and rail material, it was found that the wear of the wheel material decreases in the order of bainite, tempered martensite, and pearlite, whereas the wear of the rail material slightly increases in the order of bainite, tempered martensite, and pearlite. Further, the total wear of the wheel material and the rail material combined was smallest in the case where the microstructure of the wheel material was pearlite. Though the above are the results of an experiment using a wheel material with a Brinell hardness of around 250, the same tendency was confirmed when using a wheel material with even higher hardness.

TABLE 1

| | Micro- | Chemical Composition (mass %) | | | | | | | | | | | Hardness | |
|---|---|---|---|---|---|---|---|---|---|---|---|---|---|---|
| | structure | C | Si | Mn | P | S | Al | Cu | Ni | Cr | Mo | V | (HB) | Remarks |
| Wheel Material C | Tempered | 0.76 | 0.35 | 1.16 | 0.014 | 0.006 | 0.024 | 0.26 | — | — | — | — | 221 | Comparative |
| | Martensite | | | | | | | | | | | | | Material |
| Wheel Material B | Bainite | 0.35 | 0.42 | 1.43 | 0.016 | 0.005 | 0.032 | — | 0.52 | 0.63 | 0.51 | — | 268 | Comparative |
| | | | | | | | | | | | | | | Material |
| Wheel Material A | Pearlite | 0.72 | 0.31 | 1.05 | 0.012 | 0.004 | 0.016 | — | — | 0.22 | — | — | 255 | Comforming |
| | | | | | | | | | | | | | | Material |
| Rail Material A | Pearlite | 0.82 | 0.56 | 0.52 | 0.180 | 0.004 | 0.020 | 0.78 | — | 0.78 | — | 0.055 | 400 | — |

TABLE 2

| Rail Material | | | Wheel Material | | | Total |
|---|---|---|---|---|---|---|
| | | Wear | | | Wear | Wear |
| Test | | (A) | Test | | (B) | (A) + (B) |
| Piece | Structure | (g) | Piece | Structure | (g) | (g) |
| Rail | Pearlite | 0.13 | Wheel | Pearlite | 0.79 | 0.92 |
| Material A | | 0.12 | Material A | | 0.77 | 0.89 |
| | | 0.08 | Wheel | Tempered | 1.95 | 2.03 |
| | | 0.08 | Material C | Martensite | 1.90 | 1.99 |
| | | 0.08 | Wheel | Bainite | 2.89 | 2.97 |
| | | 0.05 | Material B | | 2.43 | 2.48 |

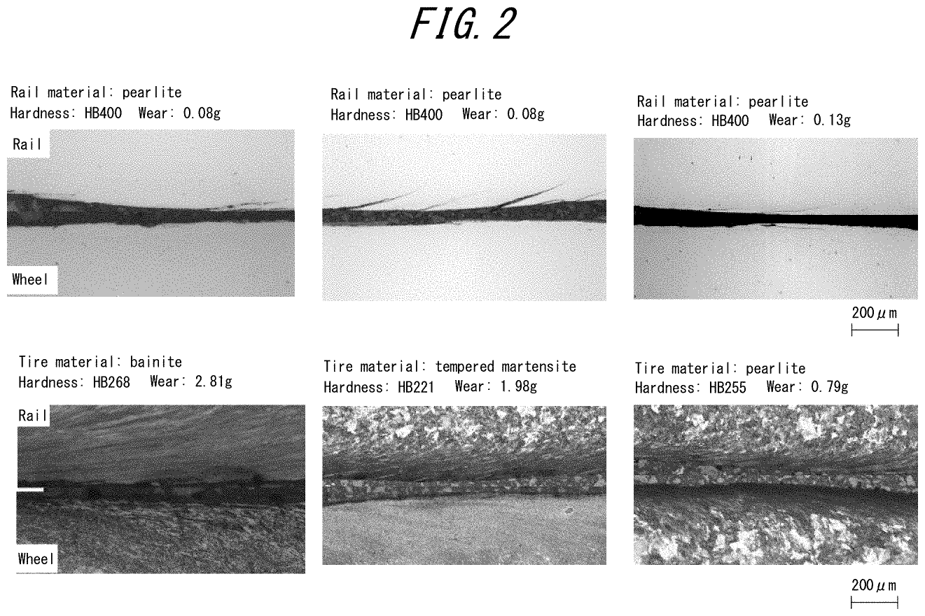

Next, the surface damage of each of the rail material and wheel material after the above wear test was examined. Microscope photographs of the surfaces of the rail material and wheel material after the wear test are shown in FIG. 2. The upper column of FIG. 2 shows the state of the surface of the test piece after mirror polishing, and the lower column of FIG. 2 shows the state of the same test piece after etching in nital solution (a mixed solution of nitric acid with a concentration of 1% and alcohol).

As shown in FIG. 2, damages such as obvious cracks were not found in the surface of the wheel material after the wear test when using wheel material comprising either of pearlite structure, bainite structure, and tempered martensite structure. For the rail material, on the other hand, when the wheel material is a pearlite structure, a notable crack was not observed in the rail material surface. However, when tempered martensite structure or bainite structure is used as the wheel material, cracks occurred in the surface of the rail material. In other words, it can be seen that when using a wheel comprising tempered martensite structure or bainite structure, surface damage is not caused in the wheel itself but damage is caused in the rail material surface.

From the above test results, it was found that, even if the hardness of the wheel material is nearly the same, the damage in the rail surface can be reduced while reducing the total wear of the rail material and wheel material, by using pearlite as the microstructure of the wheel material. Therefore, in the disclosure, the microstructure of the wheel material is a pearlite structure.

Influence of Pearlite Lamellar Spacing

Next, the influence of the lamellar spacing of a pearlite structure on the wear and surface damage of both the wheel material and rail material, when using a wheel of a pearlite structure, was taken into consideration.

A pearlite structure is a lamellar structure formed by a soft ferrite and a hard cementite, and the mean interlayer distance of the lamellar structure is referred to as pearlite lamellar spacing. Three types of wheel material in which the measured pearlite lamellar spacings are 270 nm, 140 nm, and 90 nm were prepared, and each material was combined with a fixed rail material to perform wear tests. As the rail material, rail material A which has the same pearlite structure as the previous test was used.

To determine the lamellar spacing, observation of the pearlite structure was performed at 10,000 times magnification or more using a scanning electron microscope, and calculation was performed based on the number of cementite measured using the cutting method in the part with narrow lamellar spacing, in other words, the part which was appropriately observed. As the value of the lamellar spacing, a mean value of 6 fields of view was used.

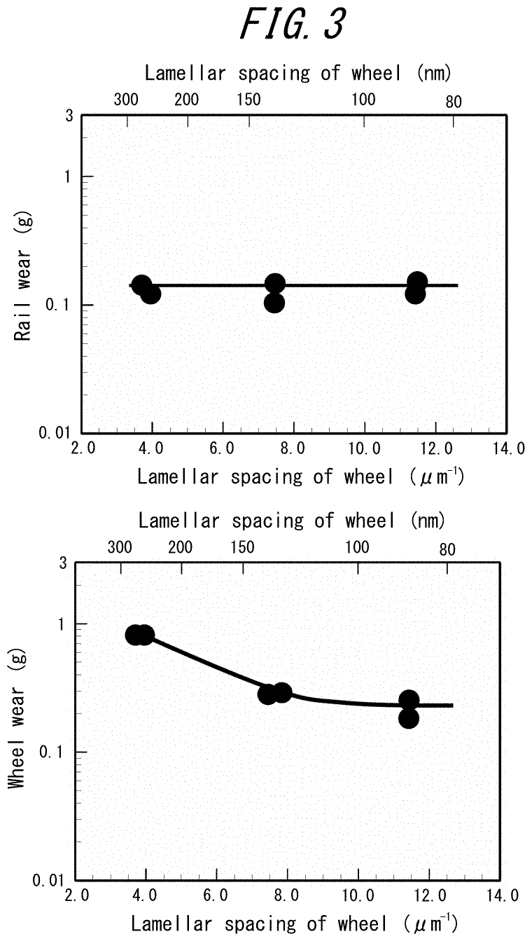

In FIG. 3, the wear of each of the rail material and wheel material in the wear test is plotted with respect to the pearlite lamellar spacing of the wheel material. As shown in the upper figure of FIG. 3, the wear of the rail material was nearly constant regardless of the pearlite lamellar spacing of the wheel material. On the other hand, it can be seen from the lower figure of FIG. 3 that, as the pearlite lamellar spacing of the wheel material is smaller, the wear of the wheel material is less.

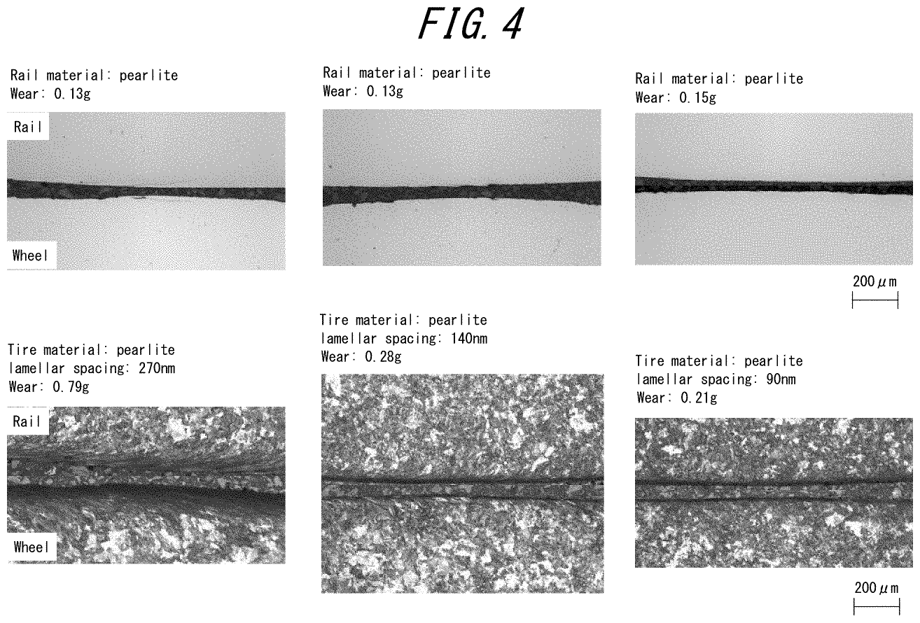

The states of the cross sections of the rail material and wheel material after the wear test are shown in FIG. 4. When the pearlite lamellar spacing of the wheel material is 270 nm, a notable plastic flow was observed in the surface of the rail material. On the other hand, when using a wheel material in which the lamellar spacing is 140 nm, and when using a wheel material in which the lamellar spacing is 90 nm, a plastic flow of the surface was hardly caused with both the wheel material and rail material, and the fatigue damage was suppressed compared to when the lamellar spacing was 270 nm.

The above experimental results show that, by adopting a pearlite structure as the microstructure of the wheel material and making the pearlite lamellar spacing small, the total wear and fatigue damage of both the wheel material and rail material can be suppressed. With these results in mind, for the railway vehicle wheel described herein, the microstructure at least in a region extending from the tread to a depth of 15 mm is a pearlite structure, and the pearlite lamellar spacing at least in the region is 150 nm or less.

The reasons for the limitations made in the disclosure will be described in detail below.

First, reasons for limiting the chemical composition of the wheel material to the above ranges will be described. Here, unless otherwise specified, the indication of “%” regarding components shall stand for “mass %”.

C: 0.65% to 0.84%

C is an important element for forming cementite, increasing hardness and strength, and improving wear resistance of the wheel material. However, these effects are small when the C content is less than 0.65%, and therefore the lower limit for the C content is 0.65%. On the other hand, although an increase in the C content causes an increase in cementite content and leads to higher hardness, ductility and toughness decreases, and therefore sufficient properties for a wheel for heavy haul railways cannot be obtained. In particular, when the C content exceeds 0.84%, pro-eutectoid cementite begins to form along prior austenite grain boundaries, and the decrease in ductility and toughness becomes pronounced. Taking into account of the above, the upper limit for the C content is 0.84%. Preferably, the C content is in a range of 0.70% to 0.84%.

Si: 0.1% to 1.5%

Si is an element that raises the pearlite equilibrium transformation temperature (TE) to reduce the pearlite lamellar spacing, and solid-solution-strengthens the ferrite in the pearlite structure to enhance the hardness and strength of the pearlite structure. Further, Si serves as a deoxidizing material and reduces the oxygen within steel. To obtain this effect, it is necessary for Si to be added in an amount of 0.1% or more. On the other hand, since an excessive addition of Si promotes decarburization and promotes formation of rail surface defects, the upper limit for the Si content is 1.5%. The Si content is preferably in a range of 0.15% to 1.3%.

Mn: 0.05% to 1.5%

Mn is an element that has an effect of enhancing the hardness of pearlite. Further, Mn serves as a deoxidizing material and reduces the oxygen within steel. In order to maintain high hardness inside the rail, Mn is added in an amount of 0.05% or more. On the other hand, since an addition of Mn exceeding 1.5% facilitates martensite transformation which has harmful effects on wear and fatigue damages of the rail, the upper limit for the Mn content is 1.5%. The Mn content is preferably in a range of 0.3% to 1.3%.

P: 0.025% or Less

Since P segregates in crystal grain boundaries and reduces toughness and ductility, it is desirable for the content thereof to be as low as possible. In the disclosure, the P content is 0.025% or less. Further, although a lower limit thereof does not need to be limited to a particular value, considering that an excessive reduction of P would lengthen refining time and increase costs, the P content is preferably 0.001% or more.

S: 0.015% or Less

S forms coarse MnS extending in the rolling direction and decreases ductility and toughness. In particular, for wheels laid in a high axle load environment, the decrease in ductility becomes pronounced. Therefore, the upper limit for the S content is 0.015%. Said content is preferably 0.007% or less, and more preferably 0.005% or less. Although no specific lower limit is given, considering that an excessive reduction of S would lengthen refining time and increase costs, the S content is preferably 0.0005% or more.

Al: 0.001% to 0.08%

Al is added as a deoxidizing material. However, if it is added in an amount exceeding 0.08%, non-metal inclusions (alumina cluster) tends to remain in steel, and causes facilitation of fatigue damage. Therefore, the upper limit for the Al content is 0.08%. Said content is preferably 0.05% or less. In order to bring out an effect of Al as a deoxidizing material, Al is preferably added in an amount of 0.003% or more. However, when, due the conditions of refining or casting, it is difficult to make non-metal inclusions (alumina) float in the slag and the alumina cannot be sufficiently removed, it is possible to perform deoxidation with Si or Mn. In such case, the Al content may be less than 0.003%, and deoxidation with Al does not have to be performed. Further, achieving an Al content of less than 0.001% is difficult with a general refining technique which is intended in the disclosure. Therefore, the lower limit for the Al content is 0.001%.

Cr: 0.05% to 1.5%

Cr increases TE to contribute to refinement of pearlite lamellar spacing, and increases hardness and strength. Therefore, it is necessary for Cr to be added in an amount of 0.05% or more. On the other hand, if Cr is added in an amount exceeding 1.5%, the generation of defects in the material as well as the quench hardenability increases, and therefore martensite which promotes rail damage is generated. In view of the above, the upper limit for the Cr content is 1.5%. More preferably, said content is in a range of 0.51% to 1.3%.

While the basic components of the wheel material described herein have been described above, the wheel material may further include one or more of Cu: 0.03% to 0.5%, Ni: 0.03% to 0.5%, Mo: 0.02% to 0.2%, V: 0.003% to 0.3%, Nb: 0.003% to 0.1%, and Ti: 0.002% to 0.02% as necessary.

Cu: 0.03% to 0.5%

By adding Cu, an even higher strength can be achieved by solid solution strengthening. To obtain this effect, it is necessary for Cu to be added in an amount of 0.03% or more. On the other hand, adding Cu in an amount of more than 0.5% facilitates surface cracking during continuous casting or rolling. Therefore, the upper limit for the Cu content is 0.5%.

Ni: 0.03% to 0.5%

Ni is an element that improves toughness and ductility. Further, since Ni inhibits Cu cracking through combined addition with Cu, when adding Cu, Ni is preferably added at the same time. Since these effects are not noticeable when the Ni content is less than 0.03%, when adding Ni, the lower limit for the Ni content is 0.03% or more. On the other hand, adding Ni in an amount of more than 0.5% increases hardenability and promotes formation of martensite. Therefore, the upper limit for the Ni content is preferably 0.5%.

Mo: 0.02% to 0.2%

Mo is an effective element for increasing strength. Since this effect is small when the Mo content is less than 0.02%, when adding Mo, the Mo content is 0.02% or more. On the other hand, adding Mo in an amount of more than 0.2% increases quench hardenability and promotes formation of bainite and martensite. Therefore, the upper limit for the Mo content is 0.2%.

V: 0.003% to 0.3%

V forms VC, VN, or the like as a fine precipitate in ferrite and is an element that contributes to achieving high hardness through precipitation strengthening of ferrite. Moreover, V also acts as a hydrogen trapping site and can be expected to exhibit an effect of inhibiting delayed fracture. To obtain these effects, it is necessary for V to be added in an amount of 0.003% or more. On the other hand, when V is added in an amount of more than 0.3%, these effects reach a plateau and the alloying cost increases dramatically. Therefore, the upper limit for the V content is 0.3%. The V content is preferably in a range of 0.005% to 0.12%.

Nb: 0.003% to 0.1%

Nb forms NbC or Nb(C,N), and refines pearlite colonies and reduces the block size through austenite refining during heat treatment of the wheel, and therefore it is effective for improving ductility and toughness. Further, Nb, similarly to V, has an effect of inhibiting delayed fracture. To obtain these effects, it is necessary for Nb to be added in an amount of 0.003% or more. On the other hand, adding Nb in an amount of more than 0.1% causes crystallization of Nb carbonitrides during the solidification process and decreases cleanliness. Therefore, the upper limit for the Nb content is 0.1%. The Nb content is preferably in a range of 0.005% to 0.05%.

Ti: 0.002% to 0.02%

Ti forms TiC or TiN, and similarly to Nb, refines pearlite colonies and reduces the block size through austenite refining during heat treatment of the wheel, and therefore it is effective for improving ductility and toughness. Further, Ti is also effective for improving delayed fracture properties. To obtain these effects, it is necessary for Ti to be added in an amount of 0.002% or more. On the other hand, adding Ti in amount of more than 0.02% causes crystallization of Ti carbonitrides during the solidification process and decreases cleanliness. Therefore, the upper limit for the Ti content is 0.02%.

The balance other than the above-described elements are Fe and incidental impurities. 0 forms oxides (mainly alumina cluster), and therefore decreases rolling fatigue damage resistance. Therefore, it is desirable for the total amount of oxygen to be kept as low as possible. However, O content of up to 0.004% would be tolerable. The O content is preferably 0.002% or less. N forms nitrides such as hard MN and decreases rolling fatigue damage resistance. Therefore, it is desirable for the amount of N to be kept as low as possible. However, N content of up to 0.005% would be tolerable. The N content is preferably 0.004% or less.

Reasons for limiting the microstructure will be described below. In the disclosure, the microstructure at least in a region extending from the wheel tread to a depth of 15 mm (hereinafter, this region is also referred to as the tread part) is a pearlite structure, and the pearlite lamellar spacing at least in the region is 150 nm or less. As described above, by adopting a pearlite structure, and not a bainite structure or a tempered martensite structure, as the microstructure of the wheel material, the wear of the rail during use can be significantly reduced and the fatigue damage of the rail surface can be suppressed. Of the entire wheel, the microstructure at least in the tread part, which is the main portion in contact with the rail, to be specific, at least in the region extending from the tread to a depth of 15 mm is made to be a pearlite structure to obtain the above effect. At a curve, the wheel flange is also brought into contact with the rail, and therefore it is preferable that the flange part is a pearlite structure as well.

Further, the pearlite lamellar spacing at least in the region extending from the wheel tread to a depth of 15 mm is 150 nm or less. As described above, by setting the lamellar spacing to be 150 nm or less, the wear of the wheel can be significantly reduced, and the fatigue damage of the rail surface can be suppressed. To obtain this effect, it is necessary to set the lamellar spacing of the wheel tread which is the portion in contact with the rail to be 150 nm or less. Considering the wear of the wheel during use, the pearlite lamellar spacing at least in the region extending from the tread to a depth of 15 mm is 150 nm or less. Although no specific lower limit is given for the lamellar spacing, there is a limit to pearlite structure refining, and under a condition in which wheel material can be manufactured, the limit is approximately 50 nm.

In addition, it is preferable to set the mean pearlite block size at least in the region extending from the wheel tread to a depth of 15 mm to be 10 μm to 30 μm. When fatigue damage or heat crack occurs in the wheel material during the use of wheel material, ductility and toughness are also important for inhibiting fracture originating from said fatigue damage or heat crack. By setting the mean pearlite block size at least in a region extending from the wheel tread to a depth of 15 mm to be 30 μm or less, ductility and toughness are improved.

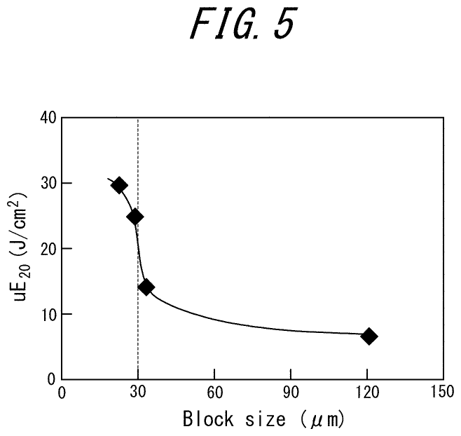

As described above, a pearlite structure is a lamellar structure formed by a soft ferrite and a hard cementite, and structure units with the same ferrite orientation are referred to as pearlite blocks. We examined the toughness of steels with the pearlite block size changed by thermal treatment. The results thereof are shown in FIG. 5. The toughness was evaluated by the Charpy impact test. Using U-notched Charpy impact test pieces of 2 mm cut out from the steel by machining, a Charpy impact test was carried out at 20° C. (room temperature), and the obtained Charpy absorption energy uE2o (J/cm²) was used as the performance index of toughness (Charpy impact value). The pearlite block size was measured by the EBSP (Electron Back Scattering Pattern) method. Using EBSP, the ferrite orientation in the region of a size of 0.25 mm×0.25 mm was measured, the block interface was traced and the mean block size was obtained by image processing. For the measurement, the size of the electron beam was set to 0.3 μm, and the boundary where the difference in ferrite orientation was 15° or more was defined as the block interface.

From FIG. 5, it can be seen that, when the mean block size exceeds 30 μm, the toughness is small, whereas if the mean block size is 30 μm or less, toughness significantly increases. Therefore, the mean pearlite block size is preferably 30 μm or less. More preferably, the mean pearlite block size is 25 μm or less. Further, although there is no preferable lower limit for the block size, achieving a block size of less than 10 μm under general manufacturing conditions is difficult from the industrial point of view, and a realistic block size is 10 μm or more.

Next, reasons for limiting the 0.2% yield strength (YS) and yield ratio of the tread part will be described below. Preferably, the wheel described herein has a 0.2% YS of 700 MPa or more and a yield ratio of 60% or more, when measured at 15 mm inside the tread. This way, the surface damage of the wheel and rail can be suppressed. With the 0.2% YS being less than 700 MPa and the yield ratio being less than 60%, surface damage of the wheel is more likely to occur, and the rail in contact is also influenced. Although no specific upper limit is given, considering the manufacturing process, the 0.2% YS is preferably 1100 MPa or less and the yield ratio is preferably 85% or less.

Further, elongation at 15 mm inside the tread is preferably 12% or more, and the Charpy impact value at 20° C. is preferably 15 J or more from the viewpoint of preventing fracture resulting from fatigue damage and heat crack in the wheel tread. If the elongation in the tread part is less than 12%, it is insufficient in relation to fractures resulting from surface damage during use. The elongation of the tread part is more preferably 14% or more. Further, the Charpy impact value of the tread part at 20° C. is preferably 15 J or more. If the Charpy impact value at 20° C. is less than 15 J, the risk of roll cracks resulting from fatigue damage during use increases. The Charpy impact value of the tread part at 20° C. is more preferably 20 J or more.

The 0.2% yield strength, yield ratio and elongation of the tread part are evaluated in a tensile test carried out at room temperature using a round bar tensile test piece of AREMA (gauge length (GL): 50 mm, diameter: 12.5 mm) collected from the tread part of the wheel material, to be specific, in a manner such that the position 15 mm inside the tread is the axial center of the test piece. The Charpy impact value was evaluated by determining the Charpy absorption energy by carrying out a Charpy impact test at 20° C. using U-notched Charpy impact test pieces of 2 mm collected from the tread part of the wheel material.

Next, a method for manufacturing the railway vehicle wheel described herein will be described below. The railway vehicle wheel described herein can be manufactured by preparing steel through steelmaking, degassing treatment and alloy adjustment in an electric heating furnace or top-blowing converter, casting the steel to obtain a material namely an ingot obtained through casting and a bloom obtained through continuous casting, subjecting the material to hot rolling and/or hot forging to form a wheel form, and then subjecting the wheel to heat treatment. When performing hot rolling and/or hot forging, the material is re-heated. The heating temperature during the re-heating is preferably from 1200° C. to 1350° C. At a heating temperature of lower than 1200° C., the working temperature at which the material is formed into a wheel form through hot forging or hot rolling becomes low, the load of press forming increases, and the formability decreases. On the other hand, if the heating temperature exceeds 1350° C., internal defects increase, and therefore the heating temperature is preferably 1350° C. or lower.

After forming the material into a wheel form through a hot rolling process and/or hot forging process, thermal treatment is performed to control the microstructure and mechanical properties. The heating temperature during the thermal treatment is Ac₃ point+50° C. or higher. When the heating temperature is lower than Ac₃ point+50° C., a sufficient strength cannot be obtained. On the other hand, if the heating temperature during the heat treatment exceeds Ac₃ point+150° C., the pearlite block size coarsens and decreases toughness and ductility. Therefore, the heating temperature during the thermal treatment is preferably Ac₃ point+150° C. or lower.

Accelerated cooling is performed after the heating process of the thermal treatment. For the accelerated cooling, it is necessary for the cooling start temperature to be 700° C. or higher, the cooling rate to be 1° C./s to 10° C./s, and the cooling stop temperature to be 500° C. to 650° C. If the cooling start temperature is lower than 700° C., the pearlite lamellar spacing becomes coarse, a sufficient strength cannot be ensured, and the wear resistance is decreased. The cooling start temperature is preferably 730° C. or higher. As the cooling means, air blast cooling or water/air mixture injection cooling can be used, and the cooling rate of the surface corresponding to the tread is in a range of 1° C./s to 10° C./s. When the cooling rate is lower than 1° C./s, the pearlite lamellar spacing exceeds 150 nm. On the other hand, if the cooling is performed at a cooling rate exceeding 10° C./s, a bainite structure and martensite structure are generated. A more preferable cooling rate range is 2° C./s to 7° C./s. It is necessary for the cooling stop temperature to be within a range of 500° C. to 650° C. If the cooling stop temperature is over 650° C., cooling will be stopped before completely finishing pearlite transformation, and the pearlite lamellar spacing becomes wide. If accelerated cooling is performed to a temperature below 500° C., a bainite structure or martensite structure is generated. After accelerated cooling, it is desirable that the wheel is air cooled. Further, after forging and/or hot rolling, cooling may be started directly. However, even in such case, the cooling start temperature needs to be 700° C. or higher, preferably 730° C. or higher.

After performing the thermal treatment, stress relief annealing may be performed as necessary. After the above treatment, finish cutting work is performed on the wheel so that a predetermined shape is obtained.

### EXAMPLES

The structures and function effects according to the disclosure are described in more detail below, by way of examples. Steels used as the material having the various chemical compositions shown in Table 3 were heated at the heating temperatures before rolling shown in Table 4, and then subjected to hot rolling to form sheet materials simulating wheels (hereinafter also referred to as wheel materials). The materials were each formed into a wheel shape, and subjected to thermal treatment under the conditions shown in Table 4 to obtain wheel materials. The obtained wheel materials were used as samples for microstructure observation, tensile test, Charpy impact test and wear test. The wheel materials and rail materials used were reproduced in a simulation of an ordinary manufacturing process, and were manufactured in a laboratory.

The microstructure at least in a region extending from the tread of each wheel material to a depth of 15 mm was determined by microscope observation of the wheel material subjected to mirror polishing followed by etching in a nital solution. For samples in which the microstructure in the region was a pearlite structure, the lamellar spacing and pearlite block size in said region were measured by the aforementioned method.

The 0.2% YS, tensile tension, yield ratio, and elongation at 15 mm inside the tread of each wheel material were measured by a tensile test carried out at room temperature. For the tensile test, round bar tensile test pieces of AREMA with gauge length (GL) of 50 mm and diameter of 12.5 mm collected from the wheel material were used. As the Charpy impact test pieces, U-notched Charpy impact test pieces of 2 mm were cut out by machining. The Charpy impact test was performed at 20° C. (room temperature) to determine the Charpy absorption energy.

The properties of the wheel materials were evaluated based on the wear and surface damage caused in the wear test. The method and conditions of the wear test are as described above. For the evaluation of surface damage, the test pieces after the wear test were subjected to mirror polishing and microscope observation. Test pieces in which a crack was found were evaluated as surface crack “found”, and test pieces in which a crack was not found were evaluated as surface crack “not found”. As the rail material which is the counterpart material in the wear test, rail steel containing 0.82% of C, 0.55% of Si, 0.55% of Mn, 0.78% of Cr, and V was used. The microstructure of the rail material was a pearlite structure, and the hardness thereof was HB400.

The observation results of the microstructure are shown in Table 4, and the test results of each test are shown in Table 5. When using wheel materials satisfying the conditions described herein for both the microstructure and the pearlite lamellar spacing, the wear of the wheel itself was small and no surface cracks were found, and further, the wear was small and no surface damages were observed in the rail which is the counterpart material as well.

On the other hand, in the comparative examples where the conditions of microstructure and pearlite lamellar spacing of the wheel material are deviated from the ranges of the disclosure, the total wear of the rail and wheel combined was large, and surface cracks were found in the rail. For example, although the microstructures of the wheel materials of test Nos. 4, 5, 6, and 7 were pearlite structures, the lamellar spacings thereof were 150 nm or more. As a result, although the wear of the rail material was fairly small, the wear of the wheel material was large, and as a result, the total wear was large.

Further, with test No. 14 in which a wheel material with a small C content was used, surface cracks were caused in the wheel material and the wear thereof was large, even though the pearlite lamellar spacing satisfied the conditions of the disclosure. Conversely, with test No. 15 in which a wheel material with a large C content was used, surface cracks were found. It can be understood that since the C content is large, ductility (elongation) and toughness is small, and damage resistance is small as well. Wheels of the examples of test Nos. 1, 8 to 13, 18, and 20 in which the pearlite block sizes were 30 um or less had higher elongation and toughness compared to the wheel material of test No. 22 in which the pearlite block size was over 30 μm.

TABLE 3

| | Chemical Composition (mass %) | | | | | | | | | | | | | |
|---|---|---|---|---|---|---|---|---|---|---|---|---|---|---|
| Steel | C | Si | Mn | P | S | Al | Cr | Cu | Ni | Mo | V | Nb | Ti | Remarks |
| A | 0.77 | 0.62 | 1.21 | 0.018 | 0.005 | 0.022 | 0.25 | — | — | — | — | — | — | Conforming Steel |
| B | 0.82 | 1.26 | 0.53 | 0.015 | 0.003 | 0.018 | 0.78 | — | — | — | — | — | — | Conforming Steel |
| C | 0.84 | 0.55 | 0.55 | 0.015 | 0.003 | 0.006 | 0.92 | — | — | — | — | — | — | Conforming Steel |
| D | 0.78 | 0.32 | 1.48 | 0.011 | 0.007 | 0.038 | 0.12 | — | — | — | 0.072 | — | — | Conforming Steel |
| E | 0.66 | 1.48 | 1.22 | 0.021 | 0.005 | 0.031 | 1.26 | 0.31 | 0.15 | — | — | — | — | Conforming Steel |
| F | 0.82 | 0.55 | 1.25 | 0.021 | 0.005 | 0.022 | 0.53 | — | — | — | — | 0.012 | — | Conforming Steel |
| G | 0.78 | 0.23 | 1.15 | 0.015 | 0.005 | 0.033 | 0.25 | — | — | 0.15 | — | — | 0.010 | Conforming Steel |
| H | 0.63 | 0.56 | 1.43 | 0.015 | 0.004 | 0.028 | 0.23 | — | — | — | — | — | — | Comparative Steel |
| I | 0.90 | 0.46 | 0.73 | 0.018 | 0.005 | 0.022 | — | — | — | — | — | — | — | Comparative Steel |
| J | 0.76 | 0.73 | 1.32 | 0.018 | 0.005 | 0.002 | 0.26 | — | — | — | — | — | — | Conforming Steel |
| K | 0.70 | 1.16 | 0.55 | 0.012 | 0.005 | 0.013 | 0.03 | — | — | — | — | — | — | Comparative Steel |
| L | 0.80 | 0.50 | 0.54 | 0.018 | 0.004 | 0.003 | 0.86 | — | — | — | — | — | — | Conforming Steel |
| M | 0.78 | 0.35 | 0.52 | 0.018 | 0.005 | 0.021 | 1.56 | — | — | — | — | — | — | Comparative Steel |

TABLE 4

| | | | Heating | Thermal Treatment Conditions | | | | | | | | |
|---|---|---|---|---|---|---|---|---|---|---|---|---|
| | | | Temper- | | Cooling | Cooling | | | | | | |
| | | | ature | Heating | Start | Stop | | | Wheel Material | | | |
| | | | before | Temper- | Temper- | Temper- | Cooling | | | Lamellar | Block | |
| Test | | Ac₃ | Rolling | ature | ature | ature | Rate | Other | Micro- | Spacing | Size | |
| No. | Steel | Point | (° C.) | (° C.) | (° C.) | (° C.) | (° C./s) | Treatment | structure * | (nm) | (μm) | Remarks |
| 1 | A | 737 | 1250 | 810 | 750 | 520 | 4 | — | P | 130 | 16 | Example |
| 2 | A | 737 | 1250 | 820 | 770 | 500 | 16 | Tempering | TM | — | — | Comparative Example |
| 3 | A | 737 | 1250 | 800 | 770 | 530 | 12 | — | B | — | — | Comparative Example |
| 4 | A | 737 | 1220 | 830 | 750 | 530 | 0.6 | — | P | 160 | 17 | Comparative Example |
| 5 | A | 737 | 1280 | 900 | 750 | 630 | 0.3 | — | P | 270 | 33 | Comparative Example |
| 6 | A | 737 | 1250 | 830 | 820 | 670 | 5 | — | P | 170 | 18 | Comparative Example |
| 7 | A | 737 | 1250 | 820 | 680 | 520 | 3 | — | P | 180 | 18 | Comparative Example |
| 8 | B | 771 | 1280 | 850 | 790 | 550 | 3 | — | P | 86 | 20 | Example |
| 9 | C | 734 | 1220 | 820 | 730 | 530 | 3 | — | P | 73 | 18 | Example |
| 10 | D | 720 | 1250 | 800 | 750 | 550 | 2 | — | P | 150 | 18 | Example |
| 11 | E | 790 | 1250 | 860 | 820 | 520 | 7 | — | P | 65 | 17 | Example |
| 12 | F | 726 | 1230 | 880 | 800 | 530 | 3 | — | P | 100 | 13 | Example |
| 13 | G | 722 | 1220 | 820 | 730 | 550 | 3 | — | P | 145 | 13 | Example |
| 14 | H | 753 | 1260 | 850 | 730 | 520 | 4 | — | P | 150 | 19 | Comparative Example |
| 15 | I | 717 | 1260 | 830 | 750 | 550 | 4 | — | P | 103 | 17 | Comparative Example |
| 16 | B | 771 | 1280 | 870 | 780 | 400 | 7 | — | B | — | — | Comparative Example |
| 17 | B | 771 | 1270 | 860 | 800 | 510 | 15 | Tempering | TM | — | — | Comparative Example |
| 18 | J | 742 | 1250 | 830 | 760 | 520 | 5 | — | P | 125 | 18 | Example |
| 19 | K | 783 | 1250 | 850 | 790 | 530 | 2 | — | P | 160 | 16 | Comparative Example |
| 20 | L | 738 | 1250 | 800 | 750 | 500 | 5 | — | P | 85 | 18 | Example |
| 21 | M | 736 | 1260 | 840 | 780 | 520 | 8 | Tempering | M | — | — | Comparative Example |
| 22 | B | 771 | 1250 | 950 | 810 | 510 | 3 | — | P | 92 | 38 | Example |

* P: Pearlite, B: Bainite, M: Martensite, TM: Tempered Martensite

TABLE 5

| | Wheel Material | | | | | | | | | | |
|---|---|---|---|---|---|---|---|---|---|---|---|
| | | | | | 20° C. | | | Rail Material | | | |
| | | | | | Charpy | Wear Test | | Wear Test | | Total | |
| | Tensile Test Results | | | | Absorp- | Results | | Results | | Wear | |
| | | | Yield | Elonga- | tion | Wear | | Wear | | (A) + | |
| Test | YS | TS | Ratio | tion | Energy | (B) | Surface | (A) | Surface | (B) | |
| No. | (MPa) | (MPa) | (%) | (%) | (J) | (g) | Crack | (g) | Crack | (g) | Remarks |
| 1 | 832 | 1145 | 72.7 | 13.2 | 31 | 0.22 | Not Found | 0.13 | Not Found | 0.35 | Example |
| 2 | 986 | 1186 | 83.1 | 20.3 | 40 | 0.51 | Not Found | 0.10 | Found | 0.61 | Comparative Example |
| 3 | 868 | 1150 | 75.5 | 16.6 | 42 | 0.78 | Not Found | 0.11 | Found | 0.89 | Comparative Example |
| 4 | 721 | 1020 | 70.7 | 15.4 | 28 | 0.27 | Not Found | 0.09 | Found | 0.36 | Comparative Example |
| 5 | 510 | 910 | 56.0 | 17.1 | 15 | 0.73 | Not Found | 0.07 | Found | 0.80 | Comparative Example |
| 6 | 520 | 993 | 52.4 | 16.4 | 28 | 0.76 | Not Found | 0.05 | Found | 0.81 | Comparative Example |
| 7 | 491 | 876 | 56.1 | 18.0 | 27 | 0.83 | Not Found | 0.06 | Found | 0.89 | Comparative Example |
| 8 | 922 | 1327 | 69.5 | 13.0 | 24 | 0.18 | Not Found | 0.13 | Not Found | 0.31 | Example |
| 9 | 1027 | 1468 | 70.0 | 12.6 | 22 | 0.15 | Not Found | 0.13 | Not Found | 0.28 | Example |
| 10 | 803 | 1082 | 74.2 | 13.5 | 25 | 0.21 | Not Found | 0.12 | Not Found | 0.33 | Example |
| 11 | 1111 | 1537 | 72.3 | 14.1 | 19 | 0.13 | Not Found | 0.15 | Not Found | 0.28 | Example |
| 12 | 922 | 1286 | 71.7 | 13.5 | 28 | 0.20 | Not Found | 0.11 | Not Found | 0.31 | Example |
| 13 | 816 | 1082 | 75.4 | 14.3 | 30 | 0.21 | Not Found | 0.10 | Not Found | 0.31 | Example |
| 14 | 726 | 950 | 76.4 | 15.1 | 53 | 0.33 | Found | 0.06 | Not Found | 0.39 | Comparative Example |
| 15 | 902 | 1301 | 69.3 | 8.2 | 10 | 0.18 | Found | 0.15 | Not Found | 0.33 | Comparative Example |
| 16 | 926 | 1201 | 77.1 | 15.7 | 31 | 0.56 | Not Found | 0.09 | Found | 0.65 | Comparative Example |
| 17 | 1053 | 1253 | 84.0 | 19.8 | 40 | 0.48 | Not Found | 0.09 | Found | 0.57 | Comparative Example |
| 18 | 860 | 1303 | 66.0 | 13.3 | 33 | 0.18 | Not Found | 0.12 | Not Found | 0.30 | Example |
| 19 | 650 | 1022 | 63.6 | 14.6 | 46 | 0.70 | Not Found | 0.07 | Not Found | 0.77 | Comparative Example |
| 20 | 955 | 1401 | 68.2 | 13.3 | 36 | 0.12 | Not Found | 0.07 | Not Found | 0.19 | Example |
| 21 | 922 | 1410 | 65.4 | 5.3 | 6 | 0.10 | Not Found | 0.10 | Found | 0.20 | Comparative Example |
| 22 | 963 | 1352 | 71.2 | 10.3 | 14 | 0.17 | Not Found | 0.12 | Not Found | 0.29 | Example |

As described above, by optimizing the chemical composition of the wheel material and controlling the microstructure and pearlite lamellar spacing of the wheel tread part, the total wear of the wheel material and rail material could be reduced and generation of surface defects in both the wheel and rail could be suppressed. This way, life of not only the wheel but also the rail can be remarkably improved. In addition, by finely controlling the pearlite block size, the ductility and toughness can further be improved, and a railway vehicle wheel with excellent wear resistance and damage resistance can be obtained. Wheels for railway vehicle described herein which have excellent characteristics are particularly effective as wheels used under severe environments such as heavy haul railways.

1. A method for manufacturing a railway vehicle wheel comprising:
preparing steel by steelmaking in an electric heating furnace or converter, the steel containing, in mass %, 0.65% to 0.84% of C, 0.1% to 1.5% of Si, 0.05% to 1.5% of Mn, 0.025% or less of P, 0.015% or less of S, 0.001 zip to 0.08% of Al, and 0.05% to 1.5% of Cr, the balance being Fe and incidental impurities;
casting the steel to obtain a material;
subjecting the material to hot rolling and/or hot forging to form a wheel;
heating the formed wheel to a heating temperature of Ac₃ point+50° C. or higher;
subjecting the wheel to accelerated cooling at a cooling start temperature of 700° C. or higher, a cooling rate of 1° C./s to 10° C./s, a cooling stop temperature of 500° C. to 650° C.; and
then subjecting the wheel to air cooling.

2. The method for manufacturing a railway vehicle wheel according to claim 1, wherein the steel further contains, in mass %, one or more of: 0.03% to 0.5% of Cu; 0.03% to 0.5% of Ni; 0.02% to 0.2% of Mo; 0.003% to 0.3% of V; 0.003% to 0.1% of Nb; and 0.002% to 0.02% of Ti.

3. The method for manufacturing the railway vehicle wheel according to claim 1, wherein the heating temperature is Ac₃ point+150° C. or lower.

4. The method for manufacturing the railway vehicle wheel according to claim 2, wherein the heating temperature is Ac₃ point+150° C. or lower.

5. The method for manufacturing the railway vehicle wheel according to claim 1, wherein the railway vehicle wheel has a microstructure at least in a region extending from a tread to a depth of 15 mm is a pearlite structure, a pearlite lamellar spacing at least in the region is 150 nm or less, and the region has a mean pearlite block size of 30 μm or less.

6. The method for manufacturing the railway vehicle wheel according to claim 2, wherein the railway vehicle wheel has a microstructure at least in a region extending from a tread to a depth of 15 mm is a pearlite structure, a pearlite lamellar spacing at least in the region is 150 nm or less, and the region has a mean pearlite block size of 30 or less.

7. The method for manufacturing the railway vehicle wheel according to claim 3, wherein the railway vehicle wheel has a microstructure at least in a region extending from a tread to a depth of 15 mm is a pearlite structure, a pearlite lamellar spacing at least in the region is 150 nm or less, and the region has a mean pearlite block size of 30 μm or less.

8. The method for manufacturing the railway vehicle wheel according to claim 4, wherein the railway vehicle wheel has a microstructure at least in a region extending from a tread to a depth of 15 mm is a pearlite structure, a pearlite lamellar spacing at least in the region is 150 nm or less, and the region has a mean pearlite block size of 30 μm or less.

9. The method for manufacturing the railway vehicle wheel according to claim 1, wherein the material is re-heated to a temperature of 1200° C. to 1350° C. prior to subjecting the material to hot rolling and/or hot forging to form a wheel.

10. The method for manufacturing the railway vehicle wheel according to claim 2, wherein the material is re-heated to a temperature of 1200° C. to 1350° C. prior to subjecting the material to hot rolling and/or hot forging to form a wheel.

11. The method for manufacturing the railway vehicle wheel according to claim 3, wherein the material is re-heated to a temperature of 1200° C. to 1350° C. prior to subjecting the material to hot rolling and/or hot forging to form a wheel.

12. The method for manufacturing the railway vehicle wheel according to claim 4, wherein the material is re-heated to a temperature of 1200° C. to 1350° C. prior to subjecting the material to hot rolling and/or hot forging to form a wheel.

13. The method for manufacturing the railway vehicle wheel according to claim 5, wherein the material is re-heated to a temperature of 1200° C. to 1350° C. prior to subjecting the material to hot rolling and/or hot forging to form a wheel.

14. The method for manufacturing the railway vehicle wheel according to claim 6, wherein the material is re-heated to a temperature of 1200° C. to 1350° C. prior to subjecting the material to hot rolling and/or hot forging to form a wheel.

15. The method for manufacturing the railway vehicle wheel according to claim 7, wherein the material is re-heated to a temperature of 1200° C. to 1350° C. prior to subjecting the material to hot rolling and/or hot forging to form a wheel.

16. The method for manufacturing the railway vehicle wheel according to claim 8, wherein the material is re-heated to a temperature of 1200° C. to 1350° C. prior to subjecting the material to hot rolling and/or hot forging to form a wheel.
